(19) United States
(12) Patent Application Publication
(10) Pub. No.: US 2003/0223137 A1
(43) Pub. Date: Dec. 4, 2003

(54) Reflective sheet, articles made therefrom and methods of using same

(76) Inventors: Yoshinori Araki, Higashine-city (JP); Yorinobu Takamatsu, Sagamihara-city (JP)

Correspondence Address: 3M INNOVATIVE PROPERTIES COMPANY, PO BOX 33427, ST. PAUL, MN, 55133-3427, US

(21) Appl. No.: 10/407,310

(22) Filed: Apr. 4, 2003

(30) Foreign Application Priority Data
Apr. 5, 2002 (JP) 2002-103730

(51) Int. Cl. G02B 5/08; G02B 7/182

(52) U.S. Cl. 359/883

(57) ABSTRACT

A reflective sheet comprising a prismatic layer and a seal layer is provided. The prismatic layer comprises cells of prismatic projections surrounded by raised elements. The height of the raised elements is greater than the height of the prismatic projections. The seal layer is adhered to the raised projections. A space or gap is provided between the peaks of the prismatic projections and the seal layer. The seal layer comprises a crystalline polymer, a self-adherent polymer and an inorganic pigment. The seal layer acts as an adhesive layer to adhere the reflective sheet to a substrate. The self-adherent polymer is compatible with the crystalline polymer at a temperature equal to or higher than the melting point of the crystalline polymer. There is a high peel strength between the seal layer and raised elements. The reflective sheet is easily positioned on the substrate prior to it being finally adhered the substrate.

### CROSS REFERENCE TO RELATED APPLICATION

This application claims priority from Japanese Application 2002-103730, filed Apr. 5, 2002.

### FIELD OF THE INVENTION

This invention relates to reflective sheets, articles made from reflective sheets and methods of making reflective sheets.

### BACKGROUND

Reflective sheets which utilize a plurality prismatic projections as reflection elements are known. Such sheets, sometimes also referred to as retroreflective sheets, are disclosed in U.S. Pat. No. 4,025,159 (corresponding to JP-A-52-110592), U.S. Pat. No. 4,775,219, JP-A-60-100103 and JP-A-6-50111.

The prismatic projections are most commonly cube corner projections and are integrally formed with a sheet-form base material to form the reflective sheet. The resin used to form the sheet is usually highly transparent, having a refractive index of 1.4 to 1.7. Examples of such resins include acrylic resins, epoxy-modified acrylic resins, polycarbonate resins.

The reflective sheet may be produced, for example, as follows:

First, the prismatic sheet may be laminated over the surface of the seal layer while leaving a gap between the prismatic projections and the seal layer. The sheet is then typically heat embossed from the back surface of the seal layer. The sheet is placed so that the surface having the prismatic projections faces the surface of the seal layer. Heat embossing forms the ridge elements formed when a part of the seal layer softens and contacts the prismatic sheet. The ridge elements function as a kind of a hot-melt adhesive so that the ridge elements and the prismatic sheet are adhered each other after the structure is cooled. The prismatic sheet and the seal layer are arranged with respect to each other so that between the areas of boding there is a gap or space between the seal layer and the prismatic projections.

It is necessary that a separate layer of adhesive be used to fasten the resulting prismatic sheet to a substrate. A pressure-sensitive adhesive is often used as the adhesive layer. Pressure sensitive adhesives provide a good means for attaching the sheet to the substrate. However, these adhesives do have a high flowability at room temperature (25° C.). This limits the use of these materials for uses other than as an adhesive layer.

Prismatic sheets in which raised elements are integrally formed with the sheet are also known. See U.S. Pat. Nos. 4,025,159; 5,946,134; 5,882,796; and 5,910,858. In these reflective sheets the sheet is also adhered to substrate by the use of a separate adhesive layer.

When a reflective sheet is adhered to a substrate, it is placed on the substrate and then positioned exactly to finish the adhesion to the substrate. Positioning of the reflective sheet is usually carried out at room temperature (about 25° C.). In this process, the reflective sheet is typically removed from the substrate and then repositioned on the substrate several times. In order to do this, back surface of the seal layer, that is the one in contact with the substrate, preferably has little or no cold tack. On the other hand, the surface of the seal layer to be adhered to the ridge elements is adhered only to a tip end portion of the ridge element. This is a relatively small area compared with the total area of the prismatic sheet. As a result, high peel strength is needed at room temperature to adequately secure the seal layer to the ridge elements.

Since the front and back surfaces are to be joined in very different manners, the separate adhesive layer has been provided on the back surface of the seal layer. However, it would be desirable to avoid the use of a separate adhesive layer. The use of such a layer complicates the use of the sheet. It increases the cost of the sheet. It requires additional time and effort during manufacture of a reflective article such as a sign.

### SUMMARY

The present invention provides, in one embodiment, a reflective sheet that comprises:

(a) a prismatic layer having a surface having a plurality of cells each comprising a plurality of prismatic projections and a raised element which defines each of the cells;

(b) a heat activated seal layer adhered to the raised element, the seal layer comprising a crystalline polymer, a self-adherent polymer and an inorganic pigment; and a space between the prismatic projections and the seal layer.

In another embodiment, the present invention provides an article comprising the reflective sheet adhered to a substrate via the seal layer.

In yet another embodiment, the present invention provides a method of making the reflective sheet. The method comprises the steps of:

(a) providing the prismatic layer and the seal layer;

(b) contacting the seal layer to the raised elements;

(c) maintaining a separation between the prismatic projections and the heat seal layer even though the seal layer contacts the raised elements;

(d) heating the seal layer to a temperature sufficient to reach the melting point of the crystalline polymer where the seal layer contacts the raised elements; and

(e) cooling said seal layer to room temperature.

The present invention provides a reflective sheet that has a high peel strength between the seal layer and the raised elements while at the same time providing a layer that can be easily positioned on a substrate before being finally adhered to a substrate. The present invention further provides a reflective sheet that can be directly adhered to a substrate without the need to employ a separate adhesive layer as a result there is no need to provide an adhesive as a discrete third layer in the construction. Consequently, the sheet of the present invention is less costly to produce.

### DESCRIPTION OF THE DRAWINGS

In the following Figures, like reference numbers in the various views refer to the same features.

FIG. 1 represents one embodiment of the invention and is a cross-sectional view of the reflective sheet of the invention applied to a substrate.

FIG. 2 is a plan view of the reflective sheet of the invention as seen through surface 15 of embodiment of FIG. 1.

### DESCRIPTION

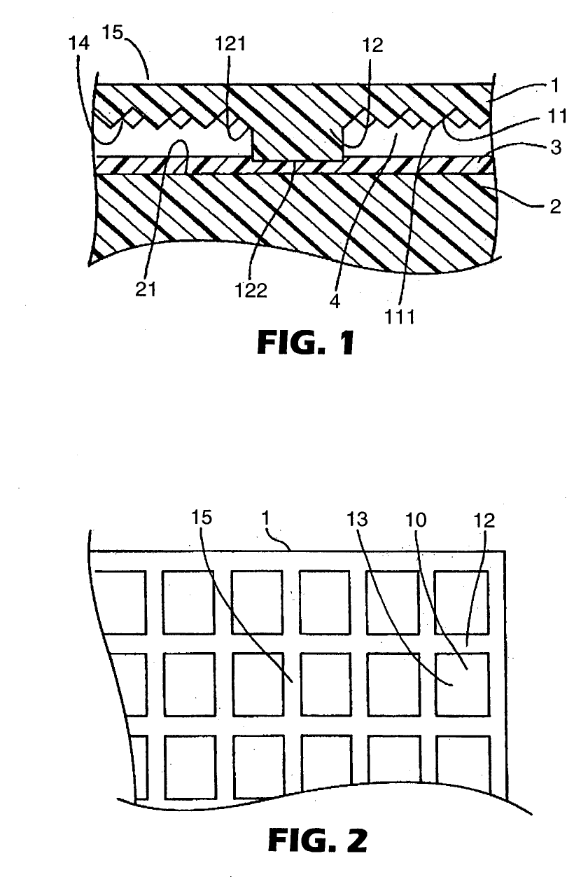

Referring to the Figures, FIG. 1 shows the reflective sheet of the invention adhered to a substrate. The reflective sheet comprises prismatic sheet (1) and seal layer (3) laminated to prismatic sheet (1) at raised elements (12). Prismatic sheet (1) has a back surface (14) that comprises a plurality of prismatic projections (11) and raised elements (12). The raised elements (12) each surround and provide a boundary to a prismatic region (10) in which the prismatic projections (11) are present to define a cell (13). As shown in FIG. 1, each cell (13) contains a plurality of the prismatic projections (11). In this embodiment of the reflective sheet, the contour of the raised ridge elements (12) can be seen through the surface (15) as shown in FIG. 2.

The prismatic sheet (1) further comprises surface (15), which is opposed to the back surface (14). Surface 15 is a light-incident surface upon which ambient light impinges. The light which impinges upon surface (15) passes through sheet (1) and is reflected by the prismatic projections (11).

Substrate (2) is adhered to sheet (1) via seal layer (3) at surface (21) of seal layer (3). The contour of the cell (13) as shown in FIGS. 1 and 2 is rectangular. However, the contour of the cells is not limited to a rectangular shape. It may be any shape desired such as, for example, a polygon such as a parallelogram, trapezoid or hexagon, a circle, or any other shape.

The raised element (12) comprises an integral part of the prismatic layer. It may be bonded to the prismatic layer at its base (121) to the back surface (14) of the prismatic sheet. Alternatively, it preferably comprises a continuous projection in the body of the prismatic layer. In either case, it contacts and is adhered to the seal layer (3) at its top (122). The raised element (12) separates the prismatic projections of layer (1) from seal layer (3) so that there is a space or gap between the seal layer (3) and the back surface (14) of the prismatic sheet. This is achieved because the height of the raised ridge element (12) as measured from the surface (15) to top (122) is greater than the height of the prismatic projections as measured from surface (15) to apexes (111).

The Prismatic Layer

The prismatic layer used in the present invention is disclosed in, and may be produced by methods disclosed in, the patent publications cited above. Typically, the resin used to form the prismatic layer is highly transparent, that is one having a refractive index of 1.4 to 1.7. Examples of such resins include acrylic resins, epoxy-modified acrylic resins, polycarbonate and the like. The total light transmittance of such a resin is usually at least 70%, preferably at least 80%, more preferably at least 90%.

The shape, size and arrangement of the prismatic projections of the prismatic layer used in the present invention may be the same as those used conventionally (see U.S. Pat. No. 4,775,219). Also, the shape, size and arrangement of the raised ridge element may be the same as those used conventionally (see U.S. Pat. No. 5,946,134).

If the reflective sheet is used as the retroreflective sign, the preferred shape of the prismatic projection is a cube corner. The cube corner may have a triangular pyramid or other three-dimensional structure. In the case of the triangular pyramid cube corner, preferably, one side of the bottom triangle has a length of 0.1 to 0.3 mm, and the height is 25 to 500 μm. The bottom triangle is usually an equilateral triangle. However, it may also be an isosceles triangle or it may be a scalene triangle, that is one having different side lengths.

The area of at least one cell is usually from 3 to 40 mm², preferably from 5 to 30 mm². Typically each of the cells has approximately the same area. The proportion of the total area of the raised elements in relation to the whole area of the back surface of the prismatic layer is usually from 10 to 50%, preferably from 15 to 40%.

The shape of the cross section of the raised element may be selected to meet the needs of the designer. Typically, the cross-section is a rectangle as shown in FIG. 1. However, other shapes, such as that of a trapezoid may be used. In the case of a trapezoid, it is preferred that the shape of the raised element tapers or reduces from the base to the top of the element. The top (122) of the raised element may have a convex or concave surface if desired to increase the area available for bonding to the seal layer.

The continuous portion of the prismatic layer, that is the portion of the prismatic layer other than the raised elements and the prismatic projections, is called a land. The thickness of the land is usually from 50 to 500 μm, preferably from 70 to 300 μm. The height of the prismatic projection measured from the land to the apex (111) is usually from 20 to 400 μm, preferably from 50 to 300 μm. The height of the raised element measured from the land to the top (122) is usually from 100 to 700 μm, preferably from 150 to 600 μm.

The reflective sheet illustrated in the figures may be produced by a method comprising the steps of providing the seal layer (3) on a liner, then pressing the prismatic layer (1) against the seal layer (3) while heating so as to press adhere the raised elements (12) to the seal layer (3). The pressure used in the pressing (press adhering) step is usually from 50 g/cm² to 50 kg/cm² (from about 5 kPa to 4.9 MPa). The heating temperature depends on the melting point of the crystalline polymer and the level of the heat resistance of the components of the reflective sheet, and is usually from 60 to 200° C. It is preferable to prevent the direct contact of the raised ridge elements to the surface of the substrate through the seal layer. As shown in FIG. 1, however, the top (122) of the raised element (12) may be embedded slightly into the seal layer (3).

The thickness of the seal layer is usually from 20 μm to 200 μm, preferably from 30 μm to 150 μm. If the thickness of the seal layer is too thin, penetration of the raised elements through the seal layer may not be prevented when the prismatic sheet is adhered. If the thickness of the seal layer is too large, the seal layer may be in contact with the prismatic projections depending on the press adhering conditions or the height of the raised ridge elements once the prismatic layer is adhered to the seal layer, and thus the reflection properties tend to deteriorate.

In this way, the prismatic sheet having the raised ridge elements can be laminated to the seal layer with its back surface facing the seal layer and hot-pressed to the seal layer to complete the reflective sheet. In this way, it is possible to seal the prismatic projections so that there is a space or gap between them and the seal layer, thereby allowing them to exhibit the effective reflectivity, in particular, retroreflectivity.

The raised element (12) forms an integral part of the prismatic layer (1). The prismatic layer may be produced by integral molding in which a mold with a cavity having the same shape, size and arrangement as those of the prismatic projections (11) and the raised ridge elements (12) is used. A liquid resin is poured into the cavity and solidified in the mold. Solidification may be carried out by cooling of the resin melt or curing a curable resin. Alternatively, the prismatic layer may be produced by a contact molding method. In this method, a sheet of the resin to be used to make the prismatic sheet is provided, and a mold having the cavity described above is pressed into the resin sheet while heating.

If the reflective sheet of the invention is used outdoors, a protective layer is preferably provided on the surface (15) of the prismatic sheet. The protective layer generally comprises a transparent polymer sheet containing a UV absorber.

If the reflective sheet of the present invention is used as a retroreflective sign, the prismatic projections preferably comprise cube corner prisms. Since the seal layer comprises the self-adherent polymer, adhesive failure, such as cracking of the seal layer, hardly occurs even if the sheet is impacted. Thus, such a sign is particularly useful as on a roadside, at an airport, or at a construction site.

The Seal Layer

As disclosed above, the seal layer comprises a crystalline polymer, a self-adherent polymer and an inorganic pigment. The seal layer seals the cells of the reflective sheet and adheres the reflective sheet of the invention to a substrate. Further, it provides enhanced peel strength between the raised elements and the seal layer while having a low cold tack so that the reflective sheet may be easily positioned, or repositioned, on a substrate prior to final adhesion to the substrate.

The self-adherent polymer enhances the adhesion between the seal layer and the raised ridge elements. The crystalline polymer enhances the heat-sensitive adhesion of the seal layer. Thus, the peel strength between the seal layer and the raised element is increased effectively after the raised element is adhered with heating. Also, there is little cold tack on the back surface (the surface that contacts a substrate) of the seal layer because the seal layer contains both the crystalline polymer and the inorganic pigment. Since there is little cold tack on the back surface of the seal layer, it is easy to position the reflective sheet in adhering it to the substrate.

The crystalline polymer used in the present invention is a polymer which is crystallized at a temperature less than its melting point. Preferably, it is crystallized at room temperature (about 20° C.-25° C.) and has a melting point exceeding 25° C. The melting point of the crystalline polymer as determined by DSC (differential scanning calorimeter) is preferably from 40° C. to 150° C., and preferably from 45° C. to 100° C. The weight-average molecular weight of the crystalline polymer is typically in the range of from 2,000 to 200,000, preferably from 3,000 to 100,000. Herein the “molecular weight” means a polystyrene-converted molecular weight determined by GPC.

The crystalline polymer preferably allows the seal layer to be peeled from an adherent when the seal layer is heated to a specific temperature (equal to or higher than the melting point of the crystalline polymer) because the peel strength is lowered to a value lower than that prior to heating. As a result, the reflective sheet can be easily removed from the substrate. Thus, it is advantageous for saving resources and protecting the environment as it is very easy to reuse or recycle the substrate.

When the crystalline polymer and the self-adherent polymer have good compatibility each other at a temperature equal to or higher than the melting point of the crystalline polymer, the ability to easily remove the reflective sheet is enhanced. Crystalline polymers which provide this characteristic contain a polycaprolactone polyol, a polycarbonate polyol, or a polyurethane synthesized by reacting the polyol with diisocyanate. The polyurethane is advantageous to enhance the peel strength between the raised elements and the seal layer.

An example of the combination of the crystalline polymer and self-adherent polymer with good compatibility is a combination of a self-adherent polymer having an aryl group in the molecule and a crystalline polymer comprising the repeating units of an alkylene group having 4 to 6 carbon atoms in the molecule. Examples of such a preferred crystalline polymer in this combination may include polycaprolactone, or polyurethane comprising the repeating units derived from 1,6-hexanediol dicarbonate in the molecule.

The proportion of the crystalline polymer used in the seal layer is usually from 5 to 55 wt %, preferably from 10 to 50 wt % based on the total weight of the seal layer. If the level of the crystalline polymer is too low, the cold tack of the seal layer may increase and the strength against the cohesive failure may decrease. In addition, the heat-sensitive adhesion property and thermal peeling property of the seal layer may decrease. If the level of the crystalline polymer is too high, the adhesion property between the seal layer and the raised ridge elements may decrease, and thus the peel strength of the raised ridge elements adhered to the seal layer may decrease.

The self-adherent polymer used in the present invention is a polymer which is tacky at room temperature (about 20° C.-25° C.).

Examples of self-adherent polymers useful in the present invention include acrylic polymers, nitrile-butadiene copolymers (e.g. NBR), styrene-butadiene copolymers (e.g. SBR), amorphous polyurethane, silicone polymers. The self-adherent polymers may be used independently or in admixture of two or more.

The self-adherent polymer used in the seal layer is preferably crosslinked. Crosslinking the self-adherent polymer can effectively increase the pressure resistance of the seal layer without deteriorating the adhesion properties of the seal layer to the raised ridge elements. As a result, direct contact of the raised elements to the substrate surface through the seal layer can be effectively prevented when the prismatic sheet is press adhered to the seal layer. If the raised elements are in direct contact with the substrate surface, the peel strength between the seal layer and the prismatic layer may be decreased and the durability of the bond between the prismatic layer and the seal layer is reduced. Reduction in the durability of the bond can result in the prismatic layer peeling off of the seal layer during the use of the reflective sheet. This phenomenon is known as pop-off. The increase of the pressure resistance of the seal layer allows the prismatic layer to be press adhered to the seal layer with a sufficiently large force (pressure), thereby effectively increasing the adhesion force (peel strength) between the raised elements and the seal layer.

Preferably, the self-adherent polymer contains a crosslinkable functional group in the molecule. Examples of useful crosslinkable functional groups include (a) photocrosslinkable functional groups such as an unsaturated double bond and aromatic ketone structures and (b) hydroxyl groups, and carboxyl groups. In addition to these crosslinkable functional groups, the self-adherent polymer preferably comprises an alkyl group having 4 to 8 carbon atoms and/or an aryl group as well as a polar group other than the above crosslinkable functional groups.

The aryl group comprises a functional group having a benzene ring in its chemical structure. Examples of such aryl groups include a phenyl group, a phenoxy group, a benzyl group, a benzoyl group, a naphthyl group, a biphenyl group. Preferable examples of the polar group include nitrogen-containing functional groups such as a nitrile group, a pyridyl group, a di-alkyl substituted amino group. The number of carbon atoms in the alkyl group is preferably 6 or less, namely 4, 5 or 6.

The proportion of the monomeric units having the above alkyl group and/or the aryl group (repeating units derived from monomers having the alkyl group or the aryl group respectively) in the self-adherent polymer is usually from 60 to 99 mole %, preferably from 70 to 98 mole %.

One example of the self-adherent polymer to be used in the present invention is an acrylic polymer prepared by copolymerizing a starting monomer mixture containing (i) an acrylate monomer having 4 to 8 carbon atoms in the molecule and/or an acrylate with an aryl group in the molecule, and (ii) a (meth)acrylate having a crosslinkable functional group in the molecule.

Examples of the monomer (i) include n-butyl acrylate, isobutyl acrylate, 2-methylbutyl acrylate, 2-ethylhexyl acrylate, isooctyl acrylate, phenoxyethyl (meth)acrylate, phenoxypropyl (meth)acrylate. Examples of the monomer (ii) include (meth)acrylic acid, fumaric acid, itaconic acid, 2-hydroxyethyl (meth)acrylate, 2-hydroxylpropyl (meth)acrylate, hydroxy-3-phenoxypropyl (meth)acrylate. When a (meth)acrylate monomer having a functional group derived from an aromatic compound as the photocrosslinkable group is used, the monomer (ii) may be omitted. Examples of the photocrosslinkable group derived from the aromatic compound include those derived from benzophenone, vinylbenzene, benzalacetophenone, cinnamylidene, coumarin, stilbene, styrylpyridine, α-phenylmaleimide, anthracene.

The acrylic polymer may be prepared by copolymerizing the starting monomer mixture containing the monomers in the specific ratio with a conventional method such as bulk polymerization, solution polymerization, suspension polymerization, emulsion polymerization.

The glass transition temperature Tg of the self-adherent polymer is usually from −50 to 10° C., preferably from −40 to 5° C., more preferably from −30 to 0° C. The molecular weight of the self-adherent polymer is chosen so that the specific adhesion force desired is achieved. The weight average molecular weight is usually from 10,000 to 1,000,000. Like conventional pressure-sensitive adhesives, a tackifier may be used in combination with the self-adherent polymer.

As described above, the self-adherent polymer is preferably crosslinked. For example, when the crosslinkable functional group is a carboxyl group, a bisamide crosslinking agent, an epoxy resin, an isocyanate compound are preferably used as the thermal crosslinking agents. When such a crosslinking agent is used, the proportion of the crosslinking component in the whole weight of the adhesive composition is usually from 0.01 to 20 wt %, preferably from 0.05 to 10 wt %.

The proportion of the self-adherent polymer employed in the seal layer is usually from 30 to 60 wt %, preferably from 31 to 55 wt % based on the total weight of the seal layer. If the level of the self-adherent polymer is too low, the adhesion property between the seal layer and the raised ridge elements may decrease. If the level of the self-adherent polymer is too high, the strength of the seal layer against the cohesive failure may decrease, and thus the peel strength of the raised ridge elements adhered to the seal layer may decrease.

The inorganic pigment used in the present invention can be a conventional white pigment or a colored pigment other than white. Examples of useful pigments include titanium oxide, zinc oxide, silicon dioxide, alumina, zirconia and iron oxide. The pigment may be a luminescent pigment provided that it does not impair the effect of the present invention. The proportion of the inorganic pigment is usually from 5 to 20 wt %, preferably from 10 to 15 wt % based on the total weight of the seal layer. If the level of the inorganic pigment is too low, the cold tack may increase and the strength against the cohesive failure may decrease. Also, the opacifying property of the seal layer may decrease. If the level of the inorganic pigment is too high, the adhesion property between the seal layer and the raised ridge elements may decrease.

Additives other than the above disclosed components may be added to the seal layer. The additive may be, for example, a tackifier resin, a thermoplastic resin which is neither crystalline nor adherent, a plasticizer, a dye, an UV absorber and a surfactant. The level of such an additive is usually 30 wt % or less based on the total weight of the seal layer.

The seal layer can be prepared by combining the self-adherent polymer, the crystalline polymer, the inorganic pigments, any other desired additives and a solvent together. The ingredients can be combined in a number of ways. For example, the ingredients may be combined in a dispersion apparatus such as a sandmill or a planetary mixer. The seal layer may then be formed by applying the composition onto a liner or the substrate.

Applying the coating composition to a surface may be carried out by using a conventional method such as a knife coating, a bar coating, a roll coating, a die coating. The coated film is usually dried at a temperature of 60 to 180° C. The drying time is usually from several ten seconds to several minutes.

The coating composition is usually prepared by dissolving the self-adherent polymer and the crystalline polymer homogeneously in a solvent to form a vehicle and dispersing the inorganic pigment homogeneously in the vehicle. It is also possible to use a mixture of the monomer mixture containing a monomer which will form the self-adherent polymer after polymerization and a cross-linking monomer, and the crystalline polymer as the above vehicle. When the monomer mixture is used, a composition comprising the monomer mixture is applied on an adherend such as the liner or the substrate, etc., and then the above monomer is polymerized (or polymerized and crosslinked) by irradiating with UV rays or electron beams to form the seal layer

The Substrate

Substrates useful in the invention are many. While they are usually metal, they can also be plastic or wood. The metal may be stainless or aluminum. Other metals may also be used. Useful plastics include polycarbonate, polyimide, an acrylic resin, polyethylene, and polypropylene.

The thickness of the substrate is usually from 250 μm to 10 mm, but not limited to such a thickness insofar as the effects of the present invention are not impaired.

The area of the surface of the substrate to be bonded to the reflective sheet is usually from 40 to 2,000 cm², but is not limited to such an area insofar as the effects of the present invention are not impaired.

Manufacture of the Reflective Sheet

The reflective sheet of the invention may be made by any number of methods. The following is an example of a useful method. The prismatic layer and the seal layer are placed into contact with one another such that the seal layer contacts the raised elements. If desired, the two layers may be laminated one to the other in order to achieve this contact. In any event, the raised elements and seal layer are hot-pressed so that the seal layer adheres to the raised elements. It should be noted that the self-adherent polymer and crystalline polymer are preferably compatible with each other in the hot or molten state. Particularly, when the heating temperature is the melting point of the crystalline polymer or more, substantially all of the self-adherent polymer and crystalline polymer are compatible with each other.

The laminate of the prismatic layer and the seal layer are then cooled to room temperature after hot-pressing. In the cooled state, the phases of the self-adherent polymer and the crystalline polymer preferably form a microphase-separation structure in which one phase in the form of microparticles is dispersed in the matrix of the other phase. The inorganic pigment is also dispersed in the seal layer in the form of particles. Since such a dispersed structure is formed in the seal layer, the particles may act as a filler to exhibit a reinforcing effect and enhance the strength of the seal layer against the cohesive failure.

The reflective sheet may then be placed on the substrate with the back surface of the seal layer facing the substrate. This combination may then be pressed together while heating, i.e. hot-pressed, to adhere the reflective sheet to the substrate. Thus, it is not necessary to use an additional adhesive in securing the reflective sheet to the substrate and it is easy to secure it to the substrate. If a white or colored pigment is used, it is possible to hide the color of the adherend under non-reflective conditions and to provide the reflective sheet with the color of the pigment rather than the color of the adherend.

### EXAMPLES

### Example 1

This example describes the production of a reflective sheet according to the present invention.

A prismatic layer having cube corner prisms as prismatic projections was produced from a polycarbonate resin by the integral molding method using a mold as is disclosed in U.S. Pat. No. 5,946,134. In the, a protective layer having a thickness of 50 μm was adhered to the surface of the prismatic layer (surface (15) of the land). The protective film was a film of polymethyl methacrylate containing a UV absorber.

The prismatic layer had the following dimensions:

| | |
|---|---|
| Thickness of land: | 220 μm |
| Height of prismatic projection: | 90 μm |
| Height of raised element: | 220 μm |
| (measured on the surface of the prismatic layer) | |
| Width of raised ridge element: | 230 μm |
| (measured on the surface of the prismatic layer) | |
| Area of one cell (prismatic area): | 11 mm² |
| (measured on the surface of the prismatic layer) | |
| Shape of the cell: parallelogram | |
| Size of prismatic layer surface: | 25 mm × 150 mm |
| (in the horizontal direction) | |

The seal layer was prepared as follows. First the composition to form the seal layer was prepared. The ratio of the crystalline polymer (C) to the self-adherent polymer (S) to the inorganic pigment (P) to the crosslinking agent for the self-adherent polymer (L) (C:S:P:L) was 35:52:13:0.2 in terms of the nonvolatile contents. The components other than the crosslinking agent were mixed together with a solvent in a sandmill to obtain a homogeneous dispersion. The solvent was a mixture of toluene and ethyl acetate and the nonvolatile content of the dispersion was 35 wt %. The crosslinking agent was then added to the dispersion and the resulting composition was used to form the seal layer.

The crystalline polymer used was crystalline polyurethane (Mn=8,900, Mw=34,000) obtained by polymerizing 1,6-hexanediol carbonate (available from DAICEL CHEMICAL INDUSTRIES, LTD., trademark: PLACCEL CD-220) with isophoronediisocyanate. The melting point of this polyurethane determined by DSC was 50° C.

The self-adherent polymer was prepared by polymerizing a mixed monomer solution containing phenoxyethyl acrylate/butyl acrylate/2-hydroxy-3-phenoxypropyl acrylate/acrylic acid in the weight ratio of 5/25/15/5. The solvent was a mixture of toluene and ethyl acetate and the nonvolatile content of the solution was 30 wt %.

The inorganic pigment used was white titanium oxide available from ISHIHARA SANGYO Co., Ltd. (CR-90). The crosslinking agent used was a bisamide type crosslinking agent.

The composition to form the seal layer was applied on the release face of the liner (available from Teijin DuPont, LTD., a polyester film treated with silicone, thickness=50 μm) with a bar set of 300 μm. The coated material was dried at 65° C. for 3 minutes and at 100° C. for 2 minutes to obtain the seal layer having a thickness of 60 μm.

This seal layer (with the liner) was placed on the above prismatic sheet so that the raised ridge elements of the prismatic sheet were in contact with the surface of the seal layer. The resulting construction was then hot-pressed using a hot laminator consisting of a steel roll which could be heated and a rubber roll. The hot-press operation was carried out so that the liner was in contact with the steel roll. The surface temperature of the steel roll was 90° C., the space between the steel roll and the rubber roll was 0, and the traveling rate of the laminator was 0.64 m/min.

The resulting reflective sheet of the invention was evaluated as follows:

Measurement of Retroreflectivity

The reflective sheet which was allowed to stand for 28 hours at room temperature after hot-pressing. Brightness was measured at three points on the surface of the reflective layer before adhering the seal layer to it. The average of the measured values was reported as the retroreflectivity (unit: cd/lux/m²). The retroreflectivity of the reflective layer was 474 cd/lux/m².

Peel Strength

After hot-pressing the seal layer and the prismatic layer, the reflective sheet was allowed to stand for 28 hours at room temperature. The sheet was then hot-pressed via the seal layer onto an aluminum substrate having a thickness of 1 mm (A505 2P alloy according to JIS H4000). Prior to hot pressing, the aluminum substrate had been degreased with a degreasing agent of Sumitomo 3M (FEY-0180). The back surface of the seal layer (that is the surface in contact with the aluminum substrate) had little cold tack. The reflective sheet of the invention was very easy to position on the substrate prior to adhering it to the substrate.

Hot-pressing was carried out by peeling the liner from the reflective sheet, applying the seal layer of the reflective sheet to the substrate and then hot-pressing with the hot laminator used in the previous hot-press operation. It was carried out so that the protective layer of the prismatic sheet was in contact with the surface of the steel roll. The surface temperature of the steel roll was 103° C., the space between the steel roll and the rubber roll was 300 μm, and the traveling rate was 0.64 m/min.

The reflective sheet was then peeled from the substrate by pulling it at a pulling rate of 300 mm/min at an angle of 90° to determine the peel strength. Failure occurred between the seal layer and the raised elements, and a portion of the seal layer was left on the raised elements.

Easy Removal Property

A sample prepared by the same method used in measuring the peel strength was used. This sample was heated at 70° C. or more and then cooled to room temperature (about 5 minutes after heating). The cooled sample was peeled so that the peeling occurred between the substrate and the seal layer to determine the thermal peel strength. The percentage of this thermal peel strength (H) to the peel strength measured above (A) (H×100/A) was determined and used as a retention factor of thermal peel strength. When this retention factor was 50% or less, it was judged to have a thermal easy removal property (OK), and when this retention factor was more than 50%, it was judged to have no thermal easy removal property (NG).

The results of the evaluations are shown in Table 1.

### Examples 2-7 and Comparative Example 1

The reflective sheets of Examples 2-7 and Comparative Example 1 were prepared as illustrated hereafter. The reflective sheets of Examples 2-7 had little cold tack like Example 1, and thus it was easy to position these reflective sheets before laminating them to the substrate. The reflective sheets of Examples 2-7 and Comparative Example 1 were also evaluated in the same way as in Example 1. The results are shown in Table 1.

### Example 2

The reflective sheet of this example was obtained in the same way as in Example 1 except that the seal layer had a thickness of 37 μm (bar set of 200 μm in the application operation).

### Example 3

The reflective sheet of this example was obtained in the same way as in Example 1 except that the ratio of the crystalline polymer (C) to the self-adherent polymer (S) (C:S) was changed from 35:52 to 43.5:43.5.

### Example 4

The reflective sheet of this example was obtained in the same way as in Example 1 except that the ratio of the crystalline polymer (C) to the self-adherent polymer (S) (C:S) was changed from 35:52 to 52:35.

### Example 5

The reflective sheet of this example was obtained in the same way as in Example 1 except that the crystalline polymer used was a polycaprolactone available from DAICEL CHEMICAL INDUSTRIES, LTD. (PLACCEL® H7, melting point=60° C.).

### Example 6

The reflective sheet of this example was obtained in the same way as in Example 1 except that the an amorphous non-adherent thermoplastic polymer (B) was added to the composition of the seal layer, and that the ratio of the nonvolatile content of the crystalline polymer (C) to the self-adherent polymer (S) to the inorganic pigment (P) to the crosslinking agent (L) to the thermoplastic polymer (B) (C:S:P:L:B) was 35:36:13:0.2:16.

The non-adherent thermoplastic polymer used in this example was a polyurethane (Mn=7,800, Mw=34,000) obtained by polymerizing polycarbonate diol available from DAICEL CHEMICAL INDUSTRIES, LTD. (PLACCEL® CD-220PL) with isophoronediisocyanate.

### Example 7

The reflective sheet of this example was obtained in the same way as in Example 6 except that the ratio of the crosslinking agent was changed from 0.2 to 0.5.

### Comparative Example 1

The reflective sheet of this comparative example was obtained in the same way as in Example 1 except that no crystalline polymer was used, and that the ratio of the self-adherent polymer was changed from 52 to 87.

TABLE 1

| | Retroflective | | Thermal Peel | Retention Factor of | Easy |
|---|---|---|---|---|---|
| | Property | Peel Strength | Strength | Peel Strength | Removal |
| | [cd/lux/m²] | [N/25 mm] | [N/25 mm] | [%] | Property |
| Example 1 | 482 | 21.7 | 4.6 | 21 | OK |
| Example 2 | 465 | 20.3 | 4.1 | 20 | OK |
| Example 3 | 480 | 23.3 | 4.9 | 21 | OK |
| Example 4 | 464 | 15.4 | 3.5 | 23 | OK |
| Example 5 | 473 | 40.1 | 10.0 | 25 | OK |
| Example 6 | 481 | 24.1 | 4.4 | 18 | OK |
| Example 7 | 479 | 17.6 | 3.3 | 19 | OK |
| Comparative | 457 | 5.8 | 6.3 | 109 | NG |
| Example 1 | | | | | |

What is claimed is:

1. A reflective sheet comprising:
(a) a prismatic layer having a surface having a plurality of cells each comprising a plurality of prismatic projections and a raised element which defines each of the cells;
(b) a heat activated seal layer adhered to the raised element, the seal layer comprising a crystalline polymer, a self-adherent polymer and an inorganic pigment; and
(c) a space between the prismatic projections and the seal layer.

2. The reflective sheet according to claim 1 wherein the seal layer comprises a dispersion of microparticles of one of said polymers in a matrix of the other of said polymers.

3. The reflective sheet according to claim 2 wherein the seal layer comprises a dispersion of microparticles said crystalline polymer in said self-adherent polymer.

4. The reflective sheet according to claim 2 wherein the seal layer comprises a dispersion of microparticles said self-adherent polymer in said crystalline polymer.

5. The reflective sheet of claim 1 wherein said seal layer comprises from 30 to 60% by weight of said self-adherent polymer, from 5 to 55% by weight of said crystalline polymer and from 5 to 20% by weight of said pigment.

6. The reflective sheet of claim 1 wherein said self-adherent polymer has a glass transition temperature of from −50° C. to 10° C.

7. The reflective sheet according to claim 1 wherein said crystalline polymer has a melting point of greater than 25° C.

8. The reflective sheet according to claim 1 wherein said self-adherent polymer is crosslinked.

9. The reflective sheet according to claim 1 wherein said inorganic pigment is dispersed in said seal layer.

10. The reflective sheet according of claim 1, wherein the crystalline polymer is a polymer comprises repeating units derived from polycarbonate polyol or polycaprolactone polyol in the molecule.

11. The reflective sheet of claim 1 adhered to a substrate through the seal layer.

12. The reflective sheet of claim 11 wherein the substrate is selected from the group consisting of metal, plastic or wood.

13. The reflective sheet of claim 1 wherein the prismatic projections are retroreflective.

14. The reflective sheet of claim 13 wherein the retroreflective prismatic projections are cube corner prisms

15. The reflective sheet of claim 1 further comprising a protective layer on said front surface of said prismatic layer.

16. A reflective sheet comprising:
(a) a prismatic layer having a front surface and an opposed back surface, the back surface comprising (i) a plurality of cells of prismatic projections each having a peak with a first height, (ii) a raised element surrounding each cell and, which element has a top having a second height which is greater than said first height;
(b) a heat activated seal layer secured to the top of said raised elements, said seal layer comprising a crystalline polymer, a self-adherent polymer and an inorganic pigment; and
(c) a gap between said peaks of said projections and said seal layer.

17. The reflective sheet of claim 18 wherein the crystalline polymer and the self-adherent polymer comprise a dispersion of microparticles of one in a matrix of the other.

18. A method of making a reflective article according to claim 1 comprising the steps of:
(d) providing (i) a prismatic layer having a front surface and an opposed back surface, the back surface comprising a plurality of cells of prismatic projections each having a peak with a first height and a raised element surrounding each cell, which element has a top having a second height which is greater than said first height, and (ii) a heat activated seal layer comprising a crystalline polymer, a self-adherent polymer and an inorganic pigment;
(e) contacting said seal layer to the tops of said elements;
(f) maintaining a separation between the peaks of said prismatic projections and said heat seal layer;
(g) heating said seal layer to a temperature sufficient to reach the melting point of said crystalline polymer in the area of contact between the tops of said elements and said seal layer; and
(h) cooling said seal layer to room temperature.

19. The method of to claim 18 wherein said heating step causes said crystalline polymer and said self-adherent polymer to comaptibilize with each other in the molten state.

20. The method of claim 18 wherein said cooling step causes said crystalline polymer and said self-adherent polymer to form a dispersion of microparticles of one in a matrix of the other.
